(19) United States
(12) Patent Application Publication
(10) Pub. No.: US 2026/0300030 A1
(43) Pub. Date: Oct. 1, 2026

(54) ADJUSTING COMPUTATIONAL RESOURCES FOR PODS IN AN ORCHESTRATION PLATFORM

(71) Applicant: International Business Machines Corporation, Armonk, NY (US)

(72) Inventors: XuQin Zhao, San Jose, CA (US); Sheng Yan Sun, Beijing (CN); Peng Hui Jiang, Beijing (CN); Liang Guo, San Jose, CA (US)

(21) Appl. No.: 19/097,249

(22) Filed: Apr. 1, 2025

(51) Int. Cl. G06F 9/50

(52) U.S. Cl. CPC G06F 9/5077; G06F 2209/5019

(57) ABSTRACT

A computer-implemented method is provided. A processor set creates a number of groups for a number of pods in an orchestration platform. Each group from the number of groups comprises a subset of pods from the number of pods. The processor set assigns computational resources to each group from the number of groups for the number of pods. The processor set attaches the subset of pods from the number of pods to each group from the number of groups. The processor set adjusts computational resources for each group from the number of groups based on pod behavior and resource consumption patterns for the subset of pods for each group from the number of groups.

### BACKGROUND

The disclosure relates generally to adjusting computational resources for pods in an orchestration platform.

An orchestration platform is a system that automates the deployment, management, and scaling of applications, services, or workflows across distributed environments. In this case, orchestration platforms ensure seamless coordination between different components, handling dependencies, scheduling tasks, and optimizing resource utilization.

Orchestration platforms are widely used in cloud computing, containerized applications, and microservices architectures to enable high availability, fault tolerance, and scalability. In this case, orchestration platforms can be designed for various use cases such as container orchestration that manage the lifecycle of containerized applications, workflow orchestration that automates data pipelines and business processes, and infrastructure orchestration that provisions and configures cloud resources.

The computational resources allocated to an orchestration platform are critical for ensuring efficient operation and scalability. The computational resources allocated to orchestration platforms typically include CPU (central processing unit), memory, storage, and networking capacity provisioned across physical or virtual infrastructure.

### SUMMARY

According to one illustrative embodiment, a computer-implemented method is provided. A processor set creates a number of groups for a number of pods in an orchestration platform. Each group from the number of groups comprises a subset of pods from the number of pods. The processor set assigns computational resources to each group from the number of groups for the number of pods. The processor set attaches the subset of pods from the number of pods to each group from the number of groups. The processor set adjusts computational resources for each group from the number of groups based on pod behavior and resource consumption patterns for the subset of pods for each group from the number of groups. According to other illustrative embodiments, a computer system and a computer program product are also provided.

### BRIEF DESCRIPTION OF THE DRAWINGS

FIG. 1 is a pictorial representation of a computing environment in which illustrative embodiments may be implemented;

FIG. 2 is an illustration of a block diagram of a resources management environment in accordance with an illustrative embodiment;

FIG. 3 is an illustration of groups for pods in an orchestration platform in accordance with an illustrative embodiment;

FIG. 4 is a flowchart of a process for adjusting computational resources for groups of pods in accordance with an illustrative embodiment;

FIG. 5 is a flowchart of a process for attaching pods to a group in accordance with an illustrative embodiment;

FIG. 6 is a flowchart of a process for adjusting computational resources for groups of pods in accordance with an illustrative embodiment;

FIG. 7 is a flowchart of a process for adjusting computational resources for groups of pods in accordance with an illustrative embodiment;

FIG. 8 is a flowchart of a process for adjusting computational resources for groups of pods in accordance with an illustrative embodiment; and

FIG. 9 is a block diagram of a data processing system in accordance with an illustrative embodiment.

### DETAILED DESCRIPTION

A computer implemented method is provided. A processor set creates a number of groups for a number of pods in an orchestration platform. Each group from the number of groups comprises a subset of pods from the number of pods. The processor set assigns computational resources to each group from the number of groups for the number of pods. The processor set attaches the subset of pods from the number of pods to each group from the number of groups. The processor set adjusts computational resources for each group from the number of groups based on pod behavior and resource consumption patterns for the subset of pods for each group from the number of groups. As a result, the illustrative embodiments provide a technical effect of optimizing computational resource allocation across pods in the orchestration platform to avoid wasting of computational resources.

In the illustrative embodiments, as part of attaching the subset of pods from the number of pods to each group from the number of groups, the processor set further classifies the number of pods into a number of classifications based on resource consumption patterns for the number of pods using a machine learning model. Pods in each classification from the number of classifications are pods that exhibit similar or complementary behavior. The processor set attaches the subset of pods from the number of pods to each group from the number of groups based on the number of classifications. As a result, the illustrative embodiments provide a technical effect of grouping pods with similar or complementary behaviors such that the computational resource allocation for the pods within each group is more predictable and thereby makes it easier and more efficient to provision appropriate amounts of computational resources for the pods within each group.

In the illustrative embodiments, the classification for the number of pods is performed based on the resource consumption patterns for the number of pods and correlations between workloads for the number of pods. As a result, the illustrative embodiments provide a technical effect of analyzing appropriate attributes associated with operations of pods such that the computational resource allocation for the pods within each group is more predictable and thereby makes it easier and more efficient to provision appropriate amount of computational resources for the pods within each group.

In the illustrative embodiments, as part of adjusting computational resources for each group from the number of groups based on pod behavior and resource consumption pattern for the subset of pods for each group from the number of groups, the processor set further reevaluates pod behavior and resource consumption pattern for the subset of pods for each group from the number of groups. The processor set further adjusts computational resources for each group from the number of groups based on reevaluations for subsets of pods for each group from the number of groups. As a result, the illustrative embodiments provide a technical effect of dynamically readjusting computational resources for each group of pods when pod behavior and resource consumption patterns for the subset of pods changes.

In the illustrative embodiments, as part of adjusting computational resources for each group from the number of groups based on pod behavior and resource consumption patterns for the subset of pods for each group from the number of groups, the processor set further performs time-series analysis for the number of pods to identify usage trends of computational resources for the number of pods. The processor set further forecasts future computational resources usage for each pod from the number of pods based on the usage trends of computational resources for the number of pods using a machine learning model. The processor set further adjusts computational resources for each group from the number of groups based on the future computational resource usage for each pod from the number of pods. As a result, the illustrative embodiments provide a technical effect of dynamically readjusting computational resources for each group of pods based on predicted computational resources consumptions for the pods.

In the illustrative embodiments, as part of adjusting computational resources for each group from the number of groups based on pod behavior and resource consumption patterns for the subset of pods for each group from the number of groups, the processor set further identifies a number of anomalies based on historical data and real-time data associated with operations for the number of pods. The number of anomalies are irregular patterns associated with operations for the number of pods. The processor set further adjusts computational resources for each group from the number of groups based on the number of anomalies identified for the number of pods. As a result, the illustrative embodiments provide a technical effect of dynamically readjusting computational resources for the pods when irregular patterns of operations are detected for pods.

In the illustrative embodiments, the subset of pods is attached to each group from the number of groups by a third party through an application programming interface (API) for managing pods in the number of groups. As a result, the illustrative embodiments provide a technical effect of manually attaching pods to groups to optimize computational resources based on user preferences via the API for third party users.

A computer system includes a processor set, a set of one or more computer-readable storage media, and program instructions, stored in the set of one or more computer-readable storage media, to cause the processor set to perform the following computer operations. The processor set creates a number of groups for a number of pods in an orchestration platform. Each group from the number of groups comprises a subset of pods from the number of pods. The processor set assigns computational resources to each group from the number of groups for the number of pods. The processor set attaches the subset of pods from the number of pods to each group from the number of groups. The processor set adjusts computational resources for each group from the number of groups based on pod behavior and resource consumption patterns for the subset of pods for each group from the number of groups. As a result, the illustrative embodiments provide a technical effect of optimizing computational resource allocation across pods in the orchestration platform to avoid wasting of computational resources.

In the illustrative embodiments, as part of attaching the subset of pods from the number of pods to each group from the number of groups, the processor set further executes the program instructions to classify the number of pods into a number of classifications based on resource consumption patterns for the number of pods using a machine learning model. Pods in each classification from the number of classifications are pods that exhibit similar or complementary behavior. The processor set further executes the program instructions to attach the subset of pods from the number of pods to each group from the number of groups based on the number of classifications. As a result, the illustrative embodiments provide a technical effect of grouping pods with similar or complementary behaviors such that the computational resource allocation for the pods within each group is more predictable and thereby makes it easier and more efficient to provision appropriate amounts of computational resources for the pods within each group.

In the illustrative embodiments, the classification for the number of pods is performed based on the resource consumption patterns for the number of pods and correlations between workloads for the number of pods. As a result, the illustrative embodiments provide a technical effect of analyzing appropriate attributes associated with operations of pods such that the computational resource allocation for the pods within each group is more predictable and thereby makes it easier and more efficient to provision appropriate amounts of computational resources for the pods within each group.

In the illustrative embodiments, as part of adjusting computational resources for each group from the number of groups based on pod behavior and resource consumption patterns for the subset of pods for each group from the number of groups, the processor set further executes the program instructions to reevaluate pod behavior and resource consumption patterns for the subset of pods for each group from the number of groups. The processor set further executes the program instructions to adjust computational resources for each group from the number of groups based on reevaluations for subsets of pods for each group from the number of groups. As a result, the illustrative embodiments provide a technical effect of dynamically readjusting computational resources for each group of pods when pod behavior and resource consumption patterns for the subset of pods changes.

In the illustrative embodiments, as part of adjusting computational resources for each group from the number of groups based on pod behavior and resource consumption patterns for the subset of pods for each group from the number of groups, the processor set further executes the program instructions to perform time-series analysis for the number of pods to identify usage trends of computational resources for the number of pods. The processor set further executes the program instructions to forecast future computational resources usage for each pod from the number of pods based on the usage trends of computational resources for the number of pods using a machine learning model. The processor set further executes the program instructions to adjust computational resources for each group from the number of groups based on the future computational resource usage for each pod from the number of pods. As a result, the illustrative embodiments provide a technical effect of dynamically readjusting computational resources for each group of pods based on predicted computational resources consumptions for the pods.

In the illustrative embodiments, as part of adjusting computational resources for each group from the number of groups based on pod behavior and resource consumption patterns for the subset of pods for each group from the number of groups, the processor set further executes the program instructions to identify a number of anomalies based on historical data and real-time data associated with operations for the number of pods. The number of anomalies are irregular patterns associated with operations for the number of pods. The processor set further executes the program instructions to adjust computational resources for each group from the number of groups based on the number of anomalies identified for the number of pods. As a result, the illustrative embodiments provide a technical effect of dynamically readjusting computational resources for the pods when irregular patterns of operations are detected for pods.

In the illustrative embodiments, the subset of pods is attached to each group from the number of groups by a third party through an application programming interface (API) for managing pods in the number of groups. As a result, the illustrative embodiments provide a technical effect of manually attaching pods to groups to optimize computational resources based on user preferences via the API for third party users.

In the illustrative embodiments, a computer program product is provided. The computer program product includes a set of one or more computer-readable storage media and program instructions, stored in the set of one or more computer-readable storage media, for causing a processor set to perform the following computer operations. The program instructions are executable by a computer system to create a number of groups for a number of pods in an orchestration platform. Each group from the number of groups comprises a subset of pods from the number of pods. The program instructions are executable by the computer system to assign computational resources to each group from the number of groups for the number of pods. The program instructions are executable by the computer system to attach the subset of pods from the number of pods to each group from the number of groups. The program instructions are executable by the computer system to adjust computational resources for each group from the number of groups based on pod behavior and resource consumption patterns for the subset of pods for each group from the number of groups. As a result, the illustrative embodiments provide a technical effect of optimizing computational resource allocation across pods in the orchestration platform to avoid wasting of computational resources.

In the illustrative embodiments, as part of attaching the subset of pods from the number of pods to each group from the number of groups, the program instructions are further executable by the computer system to cause the computer system to classify the number of pods into a number of classifications based on resource consumption patterns for the number of pods using a machine learning model. Pods in each classification from the number of classifications are pods that exhibit similar or complementary behavior. The program instructions are further executable by the computer system to cause the computer system to attach the subset of pods from the number of pods to each group from the number of groups based on the number of classifications. As a result, the illustrative embodiments provide a technical effect of grouping pods with similar or complementary behaviors such that the computational resource allocation for the pods within each group is more predictable and thereby makes it easier and more efficient to provision appropriate amounts of computational resources for the pods within each group.

In the illustrative embodiments, the classification for the number of pods is performed based on the resource consumption patterns for the number of pods and correlations between workloads for the number of pods. As a result, the illustrative embodiments provide a technical effect of analyzing appropriate attributes associated with operations of pods such that the computational resource allocation for the pods within each group is more predictable and thereby makes it easier and more efficient to provision appropriate amounts of computational resources for the pods within each group.

In the illustrative embodiments, as part of adjusting computational resources for each group from the number of groups based on pod behavior and resource consumption patterns for the subset of pods for each group from the number of groups, the program instructions are further executable by the computer system to cause the computer system to reevaluate pod behavior and resource consumption patterns for the subset of pods for each group from the number of groups. The program instructions are further executable by the computer system to cause the computer system to adjust computational resources for each group from the number of groups based on reevaluations for subsets of pods for each group from the number of groups. As a result, the illustrative embodiments provide a technical effect of dynamically readjusting computational resources for each group of pods when pod behavior and resource consumption patterns for the subset of pods changes.

In the illustrative embodiments, as part of adjusting computational resources for each group from the number of groups based on pod behavior and resource consumption patterns for the subset of pods for each group from the number of groups, the program instructions are further executable by the computer system to cause the computer system to perform time-series analysis for the number of pods to identify usage trends of computational resources for the number of pods. The program instructions are further executable by the computer system to cause the computer system to forecast future computational resource usage for each pod from the number of pods based on the usage trends of computational resources for the number of pods using a machine learning model. The program instructions are further executable by the computer system to cause the computer system to adjust computational resources for each group from the number of groups based on the future computational resource usage for each pod from the number of pods. As a result, the illustrative embodiments provide a technical effect of dynamically readjusting computational resources for each group of pods based on predicted computational resource consumptions for the pods.

In the illustrative embodiments, as part of adjusting computational resources for each group from the number of groups based on pod behavior and resource consumption patterns for the subset of pods for each group from the number of groups, the program instructions are further executable by the computer system to cause the computer system to identify a number of anomalies based on historical data and real-time data associated with operations for the number of pods. The number of anomalies are irregular patterns associated with operations for the number of pods. The program instructions are further executable by the computer system to cause the computer system to adjust computational resources for each group from the number of groups based on the number of anomalies identified for the number of pods. As a result, the illustrative embodiments provide a technical effect of dynamically readjusting computational resources for the pods when irregular patterns of operations are detected for pods.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one or more storage media (also called "mediums") collectively included in a set of one or more storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

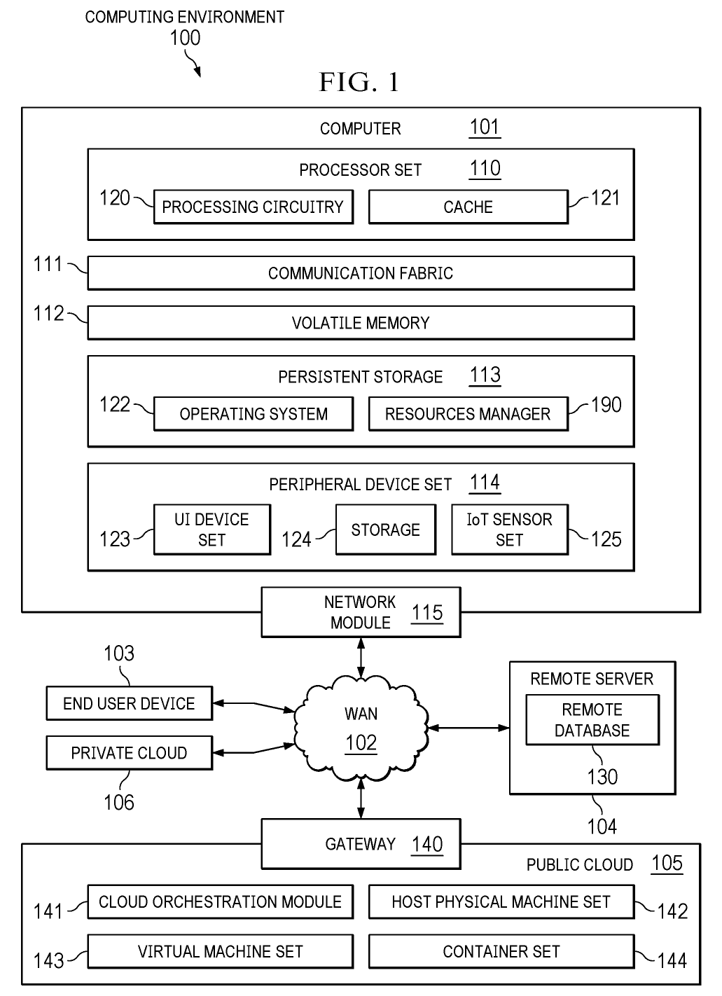

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as resources manager 190. In addition to resources manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and resources manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in resources manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in resources manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that developers often allocate excessive computational resources to individual pods in an orchestration platform to ensure smooth operation. As a result, such allocation causes significant resources waste and higher operational costs.

The illustrative embodiments also recognize and take into account that orchestration platform often lacks an efficient mechanism to manage pods with varying workloads, which results in underutilized or over-provisioned computational resources during fluctuations of workloads.

In addition, the illustrative embodiments also recognize and take into account that current resource allocation is largely reactive and manual, which makes it difficult for administrators to anticipate and address performance bottlenecks or resource shortages proactively, especially in fast-scaling environments. Further, the illustrative embodiments recognize and take into account that existing resource management techniques for orchestration platforms do not leverage data analytics effectively, thereby making detection of potential inefficiencies of computational resource allocation more difficult and preventing intelligent optimization of resources across the orchestration platform.

Thus, illustrative embodiments of the present invention provide a computer implemented method, computer system, and computer program product. A processor set creates a number of groups for a number of pods in an orchestration platform. Each group from the number of groups comprises a subset of pods from the number of pods. The processor set assigns computational resources to each group from the number of groups for the number of pods. The processor set attaches the subset of pods from the number of pods to each group from the number of groups. The processor set adjusts computational resources for each group from the number of groups based on pod behavior and resource consumption patterns for the subset of pods for each group from the number of groups.

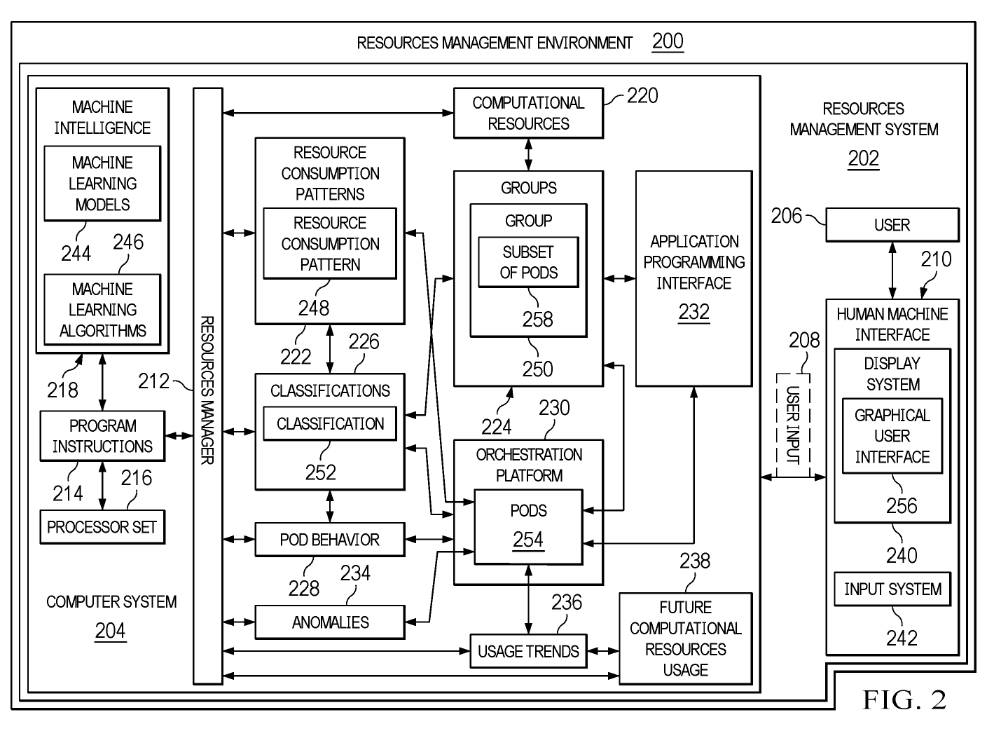

With reference now to FIG. 2, an illustration of a block diagram of a resources management environment is depicted in accordance with an illustrative embodiment. In this illustrative example, resources management environment 200 includes components that can be implemented in hardware such as the hardware shown in computing environment 100 in FIG. 1.

In this illustrative example, resources management system 202 in resources management environment 200 can be used for adjusting computational resources 220 for pods attached to each group from groups 224. In this illustrative example, computational resources 220 are infrastructure elements, either hardware or software, that enable computer system 204 to perform computing operations such as processing data or running applications. For example, computational resources 220 can include processing units such as a central processing unit (CPU) or graphical processing unit (GPU), memory, storage, network bandwidth, or any suitable resources that provide power and capacity for computer system 204 to operate.

In this illustrative example, resources management system 202 includes computer system 204 which includes resources manager 212. Resources manager 212 is located in computer system 204. Resources manager 212 may be implemented using resources manager 190 in FIG. 1.

Resources manager 212 can be implemented in software, hardware, firmware, or a combination thereof. When software is used, the operations performed by resources manager 212 can be implemented in program instructions configured to run on hardware, such as a processor unit. When firmware is used, the operations performed by resources manager 212 can be implemented in program instructions and data and stored in persistent memory to run on a processor unit. When hardware is employed, the hardware can include circuits that operate to perform the operations in resources manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include a number of machine learning models 244 and machine learning algorithms 246. The number of machine learning models 244 is a branch of artificial intelligence (AI) that enables computers to detect patterns and improve performance without direct programming commands. Rather than relying on direct input commands to complete a task, the number of machine learning models 244 relies on input data. The data is fed into the machine, one of machine learning algorithms 246 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning, unsupervised machine learning, or semi-supervised machine learning so that products or assets that do not match descriptively can nevertheless be matched. Over time, the data model from machine learning can provide a greater degree of flexibility in matching machine intelligence 218. It should be understood that in a production environment, attempts that may lead to failure are generally not allowed. In this illustrative example, refinement for machine intelligence 218 can be achieved by rewarding or penalizing the number of machine learning models 244 based on the difference between predicted and actual values. Ultimately, this process helps the number of machine learning models to improve their predictive ability to meet the required confidence.

Machine intelligence 218 can be implemented using one or more systems such as an artificial intelligence system, a neural network, a generative neural network, a Bayesian network, an expert system, a fuzzy logic system, a genetic algorithm, or other suitable types of systems.

The number of machine learning models 244 involves using machine learning algorithms 246 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 246 can include supervised machine learning algorithms and unsupervised machine learning algorithms. Supervised machine learning can train machine learning models using data containing both the inputs and desired outputs. Examples of machine learning algorithms include Gradient Boosting algorithm, XGBoost, K-means clustering, and Random Forest algorithm.

In this illustrative example, the number of machine learning models 244 can be retrained or updated using new data or outputs generated by the number of machine learning models 244 such that parameters in machine learning algorithms 246 selected for the number of machine learning models 244 can be adjusted to improve accuracy and efficiency of the number of machine learning models 244.

In this illustrative example, resources manager 212 creates a number of groups 224 for a number of pods 254 in orchestration platform 230. In this example, each group from the number of groups 224 has a subset of pods from the number of pods 254 attached. For example, group 250 from the number of groups 224 includes subset of pods 258 from the number of pods 254 attaches to it.

As depicted, orchestration platform 230 is a centralized system that automates and manages the execution of tasks, workflows, or services across distributed computing environments. In this example, orchestration platform 230 can be used in cloud computing, containerized deployments, and large-scale data processing pipelines. Orchestration platform 230 can be Kubernetes^{®} platform.

In this illustrative example, the number of pods 254 in orchestration platform 230 are the smallest deployable units that represent a group of one or more containers that share the same networking and storage resources, memory, and computational power from processing units. In this example, a pod acts as a logical host for containers that need to work together to allow the containers to communicate easily while sharing the same lifecycle. In this illustrative example, containers are lightweight, portable units that package an application and its dependencies together to ensure that the application runs consistently across different environments.

In this illustrative example, resources manager 212 assigns computational resources 220 to each group from the number of groups 224 for pods 254 attached to each group. In this example, all pods attached to each group from the number of groups 224 share computational resources 220 that are assigned to each group. It should be understood that resources manager 212 assigns a portion of computational resources 220 to each group in the number of groups 224 and is configured to dynamically adjust computational resources assigned to each group according to demand.

In this illustrative example, resources manager 212 attaches subsets of pods from the number of pods 254 to each group from the number of groups 224. In this example, resources manager 212 can attach the number of pods 254 to the number of groups 224 in a number of ways. For example, resources manager 212 can attach the number of pods 254 by first classifying the number of pods 254 based on resources consumptions patterns 222 and pod behavior 228 using the number of machine learning models 244. In this illustrative example, resources consumption patterns 222 are information or trends that describe how the number of pods 254 utilize computational resources 220 such as CPU, memory, storage, and network resources over time.

In addition, pod behavior 228 refers to the characteristics of how the number of pods 254 operates. For example, pod behavior 228 can include information such as CPU and memory usage, network traffic that include the amount of incoming and outgoing network traffic for pods, and pod lifecycle events that include pod states such as “pending”, “running”, “succussed”, “failed”, “computational resources usage”, and “Crashloopbackoff”. In addition, pod behavior 228 can also include request and limit adherence that determines whether pods 254 are staying within their allocated resource requests and limits, scaling patterns that define how often pods 254 scale up or down in response to load, restart frequency which refers to the number of times that pods 254 restart due to failures or updates, latency and response time, I/O operations, health check status, and inter-pods communications.

In this illustrative example, resources manager 212 generates a number of classifications 226 for the number of pods 254 based on resources consumption patterns 222 and pod behavior 228. In this example, pods in each classification from the number of classifications 226 are pods that exhibit similar or complementary behavior. In this example, resources manager 212 attaches subsets of pods from the number of pods 254 to each group from the number of groups 224 based on the number of classifications 226. In other words, pods that are within the same classification from the number of classifications 226 are grouped together.

As depicted, subset of pods 258 can be attached to group 250 based on classification 252, which is generated based on resource consumption pattern 248 for subset of pods 258 and pod behaviors for subset of pods 258 from pod behaviors 228. In other words, pods from subset of pods 258 are classified into classification 252 based on resource consumption pattern 248 for subset of pods 258 and pod behaviors for subset of pods 258 from pod behaviors 228. In addition, the classification for the number of pods 254 can also be performed based on resource consumption patterns 222 and correlations between workloads for the number of pods 254.

In an alternative illustrative example, attachment of the number of pods 254 to the number of groups 224 can also be performed manually or by a third party through application programming interface (API) 232 for managing pods in the number of groups 224.

As depicted, resources manager 212 can adjust computational resources 220 that are assigned to each group in the number of groups 224 based on resource consumption patterns 222 and pod behavior 228 as they change over time. For example, computational resources 220 assigned to group 250 can be dynamically adjusted based on changes in resource consumption pattern 248 for subset of pods 258 and pod behaviors for subset of pods 258 from pod behaviors 228. In other words, resources manager 212 constantly monitors pods operations in each group from the number of groups 224 and constantly reevaluate resource consumption patterns 222 and pod behavior 228 to determine if there are any changes in resource consumption patterns and pod behavior for each pod such that computational resources 220 assigned to the number of groups 224 can adjusted to optimize resource utilization.

In an alternative example, resources manager 212 can also adjust computational resources 220 for the number of groups 224 by performing time-series analysis for the number of pods 254 to identify usage trends 236 for the number of pods 254. In this example, usage trends 236 refers to the trends of computational resource consumption by the number of pods 254 over time. In this illustrative example, resources manager 212 can use the number of machine learning models 244 to forecast future computational resources usage 238 for the number of pods 254 based on usage trends 236.

As a result, resources manager 212 can adjust computational resources attached to each group from the number of groups 224 based on future computational resources usage 238 forecasted for the number of pods 254.

In yet another example, resources manager 212 can also adjust computational resources 220 for the number of groups 224 by identifying anomalies 234 based on historical data and real-time data associated with operations for the number of pods 254. In this illustrative example, the number of anomalies 234 are irregular patterns associated with operations for the number of pods 254. As a result, resources manager 212 can adjust computational resources attached to each group from the number of groups 224 based on the number of anomalies 234 identified for the number of pods 254.

In this illustrative example, user 206 can interact with computer system 204 through user inputs to computer system 204. For example, computer system 204 can receive user input 208 that includes commands for attaching specific pods from the number of pods 254 to a group from the number of groups 224 via application programming interface 232 for a third party, or commands for manually attaching specific pods from the number of pods 254 to a group from the number of groups 224.

In this illustrative example, user input 208 can be generated by user 206 using human machine interface (HMI) 210. As depicted, human machine interface 210 includes display system 240 and input system 242. Display system 240 is a physical hardware system and includes one or more display devices on which graphical user interface 256 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 256 through user input 208 generated by input system 242. Input system 242 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view resource consumption patterns 222, classifications 226, pod behavior 228, anomalies 234, usage trends 236, and future computational resources usage 238 through graphical user interface 256.

In one illustrative example, one or more solutions are present that overcome a problem with optimizing computational resources across pods in an orchestration platform. Specifically, such optimization can be achieved by attaching pods to different groups where pods in each group share the same amount of computational resources. As a result, one or more technical solutions may provide an ability to increase efficiency and performance in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which resources manager 212 in computer system 204 enables optimization of computational resources utilization for pods in an orchestration platform. In particular, resources manager 212 transforms computer system 204 into a special purpose computer system as compared to currently available general computer systems that do not have resources manager 212. In this example, computational resources utilization and adjustment performed by resources manager 212 can lead to improved speed and resource utilization for computer system 204.

In the illustrative example, the use of resources manager 212 in computer system 204 integrates processes into a practical application for optimization of computational resources utilization for pods in an orchestration platform. In other words, resources manager 212 in computer system 204 is directed to a practical application of processes integrated into resources manager 212 in computer system 204 that supports optimization of computational resources utilization for pods in an orchestration platform.

For example, efficient computational resource allocation ensures that physical resources such as CPU, memory, and storage are used to their full potential without overloading any individual component. This minimizes hardware wastage, improves the lifespan of physical resources, and reduces energy consumption. In addition, systems can avoid excessive infrastructure when resources are allocated based on actual needs, which leads to cost savings and better utilization of on-premises or cloud-based hardware.

In addition, optimization of computational resources utilization ensures that the orchestration platform can dynamically allocate and manage the computational resources required by different pods. This process leads to better application performance as each pod gets the appropriate resources it needs at any given time. Further, this process also enables faster scaling of applications that reduces bottlenecks during periods of high demand. Furthermore, efficient computational resources allocation contributes to smoother load balancing and resource sharing between multiple pods, thereby enhancing overall system reliability and reducing the likelihood of resource contention or failure.

The illustration of resources management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

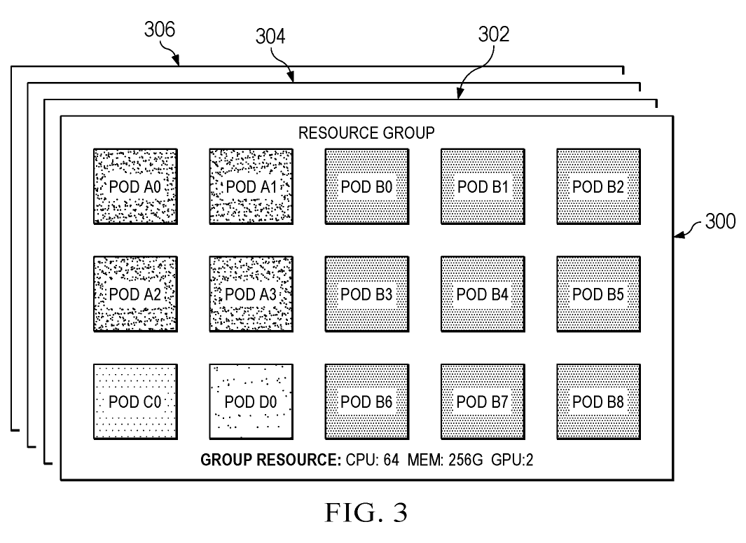

With reference now to FIG. 3, an illustration of groups for pods in an orchestration platform is shown in accordance with an illustrative embodiment. In this illustrative example, group 300, group 302, group 304, and group 306 can be examples of the number of groups 224 in FIG. 2.

In FIG. 3, a number of groups with pods are shown. For example, group 300 includes 15 pods attached to it and all 15 pods share the same amount of computational resources allocated to group 300. In this example, 64 central processing units (CPU), 256 gigabytes of memory, and 2 graphical processing units (GPU) are allocated as shareable computational resources for the 15 pods attached to group 300. As depicted, the classification of pods attached to each group shown in FIG. 3 can be performed using a machine learning model that identify pods that exhibit similar or complementary behavior based on the resource consumption patterns for the pods and correlations between workloads for the pods.

In this illustrative example, it should be understood that the pods attached to group 300, group 302, group 304, and group 306 can include all or subset of pods belonging to different owners such as Deployment, StatefulSet, or other controllers. For example, all pods or a portion of pod “A0”, pod “A1”, pod “A2”, and pod “A3” can be pods that belong to the same Deployment, while all or a portion of pod “B0”, pod “B1”, pod “B2”, pod “B3”, pod “B4”, pod “B5”, pod “B6”, pod “B7”, and pod “B8” can be pods that belong to the same StatefulSet. In a similar fashion, pod “C0” and pod “D0” can be pods that belong to other users, respectively.

The illustration of groups for pods in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

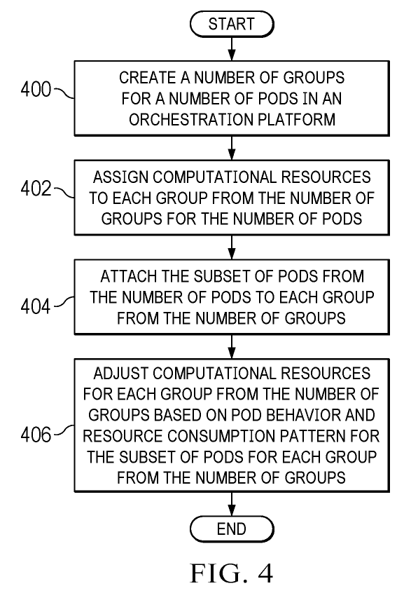

With reference now to FIG. 4, a flowchart illustrating a process for adjusting computational resources for groups of pods is depicted in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in resources manager 212 in computer system 204 in FIG. 2.

The process begins by creating a number of groups for a number of pods in an orchestration platform (step 400). The process assigns computational resources to each group from the number of groups for the number of pods (step 402). The process attaches the subset of pods from the number of pods to each group from the number of groups (step 404). The process adjusts computational resources for each group from the number of groups based on pod behavior and resource consumption pattern for the subset of pods for each group from the number of groups (step 406). The process terminates thereafter.

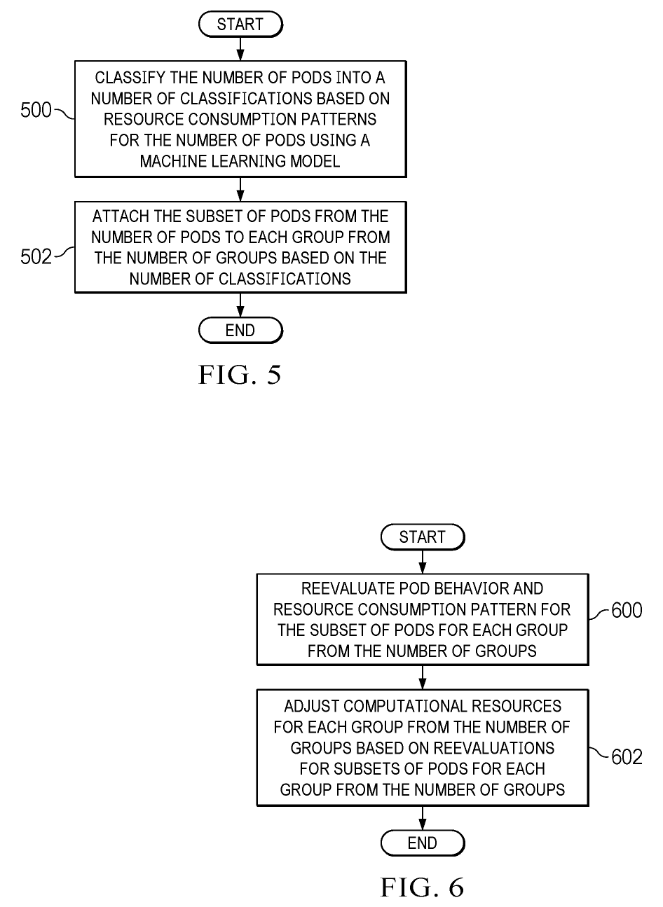

With reference now to FIG. 5, a flowchart illustrating a process for attaching pods to a group is shown in accordance with an illustrative embodiment. The process in this flowchart is an example of an implementation for step 404 in FIG. 4.

The process begins by classifying the number of pods into a number of classifications based on resource consumption patterns for the number of pods using a machine learning model (step 500). In this step, pods in each classification from the number of classifications are pods that exhibit similar or complementary behavior. The process attaches the subset of pods from the number of pods to each group from the number of groups based on the number of classifications (step 502). The process terminates thereafter.

With reference now to FIG. 6, a flowchart illustrating a process for adjusting computational resources for groups of pods is shown in accordance with an illustrative embodiment. The process in this flowchart is an example of an implementation for step 406 in FIG. 4.

The process begins by reevaluating pod behavior and resource consumption pattern for the subset of pods for each group from the number of groups (step 600). The process adjusts computational resources for each group from the number of groups based on reevaluations for subsets of pods for each group from the number of groups (step 602). The process terminates thereafter.

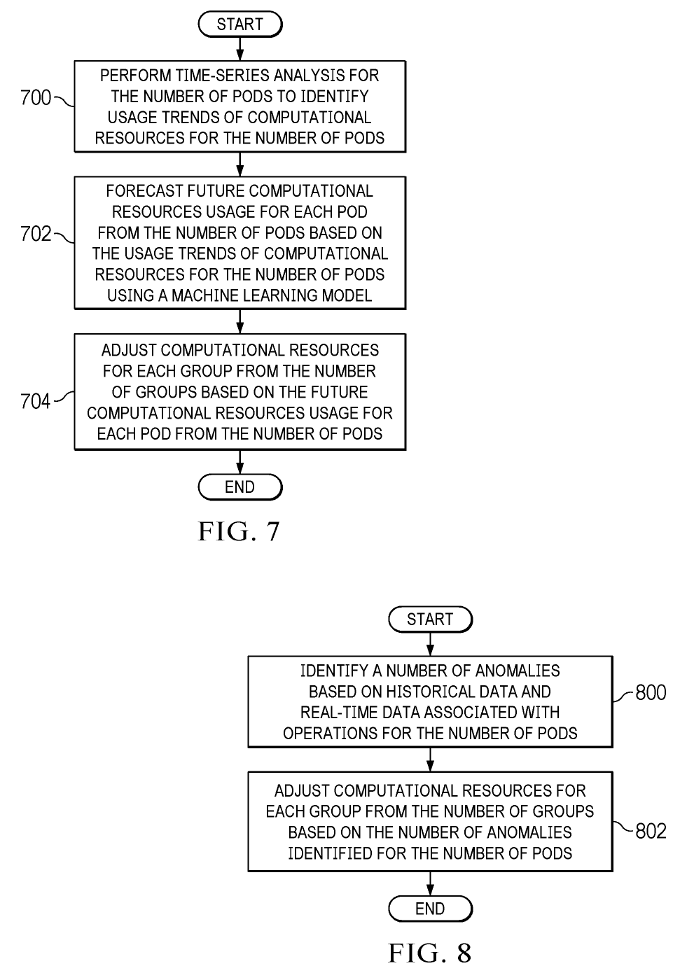

With reference now to FIG. 7, a flowchart illustrating a process for adjusting computational resources for groups of pods is shown in accordance with an illustrative embodiment. The process in this flowchart is an example of an implementation for step 406 in FIG. 4.

The process begins by performing time-series analysis for the number of pods to identify usage trends of computational resources for the number of pods (step 700). The process forecasts future computational resources usage for each pod from the number of pods based on the usage trends of computational resources for the number of pods using a machine learning model (step 702). The process adjusts computational resources for each group from the number of groups based on the future computational resource usage for each pod from the number of pods (step 704). The process terminates thereafter.

With reference now to FIG. 8, a flowchart illustrating a process for adjusting computational resources for groups of pods is shown in accordance with an illustrative embodiment. The process in this flowchart is an example of an implementation for step 406 in FIG. 4.

The process begins by identifying a number of anomalies based on historical data and real-time data associated with operations for the number of pods (step 800). In this step, the number of anomalies are irregular patterns associated with operations for the number of pods. The process adjusts computational resources for each group from the number of groups based on the number of anomalies identified for the number of pods (step 802). The process terminates thereafter.

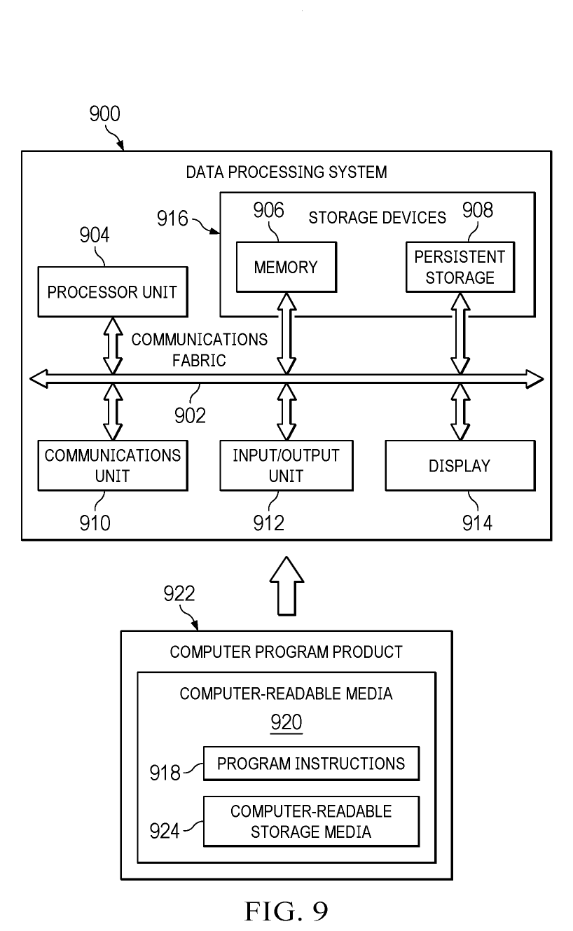

Turning now to FIG. 9, a block diagram of a data processing system is depicted in accordance with an illustrative embodiment. Data processing system 900 can be used to implement computers and computing devices in computing environment 100 in FIG. 1. Data processing system 900 can also be used to implement computer system 204 in FIG. 2. In this illustrative example, data processing system 900 includes communications framework 902, which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 916 may also be referred to as computer-readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 916, which are in communication with processor unit 904 through communications framework 902. The processes of the different embodiments can be performed by processor unit 904 using computer-implemented instructions, which may be located in a memory, such as memory 906.

These instructions are referred to as program instructions, computer usable program instructions, or computer-readable program instructions that can be read and executed by a processor in processor unit 904. The program instructions in the different embodiments can be embodied on different physical or computer-readable storage media, such as memory 906 or persistent storage 908.

Program instructions 918 are located in a functional form on computer- readable media 920 that is selectively removable and can be loaded onto or transferred to data processing system 900 for execution by processor unit 9 04. Program instructions 918 and computer-readable media 920 form computer program product 922 in these illustrative examples. In the illustrative example, computer-readable media 920 is computer-readable storage media 924.

Computer-readable storage media 924 is a physical or tangible storage device used to store program instructions 918 rather than a medium that propagates or transmits program instructions 918. Computer-readable storage media 924, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 918 can be transferred to data processing system 900 using a computer-readable signal media. The computer-readable signal media are signals and can be, for example, a propagated data signal containing program instructions 918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 920” can be singular or plural. For example, program instructions 918 can be located in computer-readable media 920 in the form of a single storage device or system. In another example, program instructions 918 can be located in computer-readable media 920 that is distributed in multiple data processing systems. In other words, some instructions in program instructions 918 can be located in one data processing system while other instructions in program instructions 918 can be located in another data processing system. For example, a portion of program instructions 918 can be located in computer-readable media 920 in a server computer while another portion of program instructions 918 can be located in computer-readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of another component. For example, memory 906, or portions thereof, may be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program instructions 918.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method comprising:
creating, by a processor set, a number of groups for a number of pods in an orchestration platform, wherein each group from the number of groups comprises a subset of pods from the number of pods;
assigning, by the processor set, computational resources to each group from the number of groups for the number of pods;
attaching, by the processor set, the subset of pods from the number of pods to each group from the number of groups; and
adjusting, by the processor set, computational resources for each group from the number of groups based on pod behavior and resource consumption pattern for the subset of pods for each group from the number of groups.

2. The computer implemented method of claim 1, wherein attaching, by the processor set, the subset of pods from the number of pods to each group from the number of groups comprises:
classifying, by the processor set using a machine learning model, the number of pods into a number of classifications based on resource consumption patterns for the number of pods, wherein pods in each classification from the number of classifications are pods that exhibit similar or complementary behavior; and
attaching, by the processor set, the subset of pods from the number of pods to each group from the number of groups based on the number of classifications.

3. The computer implemented method of claim 2, wherein the classification for the number of pods is performed based on the resource consumption patterns for the number of pods and correlations between workloads for the number of pods.

4. The computer implemented method of claim 1, wherein adjusting, by the processor set, computational resources for each group from the number of groups based on pod behavior and resource consumption pattern for the subset of pods for each group from the number of groups comprises:
reevaluating, by the processor set, pod behavior and resource consumption pattern for the subset of pods for each group from the number of groups; and
adjusting, by the processor set, computational resources for each group from the number of groups based on reevaluations for subsets of pods for each group from the number of groups.

5. The computer implemented method of claim 1, wherein adjusting, by the processor set, computational resources for each group from the number of groups based on pod behavior and resource consumption pattern for the subset of pods for each group from the number of groups comprises:
performing, by the processor set, time-series analysis for the number of pods to identify usage trends of computational resources for the number of pods;
forecasting, by the processor set using a machine learning model, future computational resources usage for each pod from the number of pods based on the usage trends of computational resources for the number of pods; and
adjusting, by the processor set, computational resources for each group from the number of groups based on the future computational resources usage for each pod from the number of pods.

6. The computer implemented method of claim 1, wherein adjusting, by the processor set, computational resources for each group from the number of groups based on pod behavior and resource consumption pattern for the subset of pods for each group from the number of groups comprises:
identifying, by the processor set, a number of anomalies based on historical data and real-time data associated with operations for the number of pods, wherein the number of anomalies are irregular patterns associated with operations for the number of pods; and
adjusting, by the processor set, computational resources for each group from the number of groups based on the number of anomalies identified for the number of pods.

7. The computer implemented method of claim 1, wherein the subset of pods is attached to each group from the number of groups by a third party through an application programming interface (API) for managing pods in the number of groups.

8. A computer system comprising:
a processor set;
a set of one or more computer-readable storage media; and
program instructions stored on the set of one or more storage media to cause the processor set to perform operations comprising:
creating a number of groups for a number of pods in an orchestration platform, wherein each group from the number of groups comprises a subset of pods from the number of pods;
assigning computational resources to each group from the number of groups for the number of pods;
attaching the subset of pods from the number of pods to each group from the number of groups; and
adjusting computational resources for each group from the number of groups based on pod behavior and resource consumption pattern for the subset of pods for each group from the number of groups.

9. The computer system of claim 8, wherein attaching the subset of pods from the number of pods to each group from the number of groups comprises:
classifying the number of pods into a number of classifications based on resource consumption patterns for the number of pods using a machine learning model, wherein pods in each classification from the number of classifications are pods that exhibit similar or complementary behavior; and
attaching the subset of pods from the number of pods to each group from the number of groups based on the number of classifications.

10. The computer system of claim 9, wherein the classification for the number of pods is performed based on the resource consumption patterns for the number of pods and correlations between workloads for the number of pods.

11. The computer system of claim 8, wherein adjusting computational resources for each group from the number of groups based on pod behavior and resource consumption pattern for the subset of pods for each group from the number of groups comprises:
reevaluating pod behavior and resource consumption patterns for the subset of pods for each group from the number of groups; and
adjusting computational resources for each group from the number of groups based on reevaluations for subsets of pods for each group from the number of groups.

12. The computer system of claim 8, wherein adjusting computational resources for each group from the number of groups based on pod behavior and resource consumption pattern for the subset of pods for each group from the number of groups comprises:
performing time-series analysis for the number of pods to identify usage trends of computational resources for the number of pods;
forecasting future computational resources usage for each pod from the number of pods based on the usage trends of computational resources for the number of pods using a machine learning model; and
adjusting computational resources for each group from the number of groups based on the future computational resources usage for each pod from the number of pods.

13. The computer system of claim 8, wherein adjusting computational resources for each group from the number of groups based on pod behavior and resource consumption pattern for the subset of pods for each group from the number of groups comprises:
identifying a number of anomalies based on historical data and real-time data associated with operations for the number of pods, wherein the number of anomalies are irregular patterns associated with operations for the number of pods; and
adjusting computational resources for each group from the number of groups based on the number of anomalies identified for the number of pods.

14. The computer system of claim 8, wherein the subset of pods is attached to each group from the number of groups by a third party through an application programming interface (API) for managing pods in the number of groups.

15. A computer program product comprising:
a set of one or more computer-readable storage media;
program instructions stored in the set of one or more computer-readable storage media to perform operations comprising:
creating, by a processor set, a number of groups for a number of pods in an orchestration platform, wherein each group from the number of groups comprises a subset of pods from the number of pods;
assigning, by the processor set, computational resources to each group from the number of groups for the number of pods;
attaching, by the processor set, the subset of pods from the number of pods to each group from the number of groups; and
adjusting, by the processor set, computational resources for each group from the number of groups based on pod behavior and resource consumption pattern for the subset of pods for each group from the number of groups.

16. The computer program product of claim 15, wherein attaching, by the processor set, the subset of pods from the number of pods to each group from the number of groups comprises:
classifying, by the processor set using a machine learning model, the number of pods into a number of classifications based on resource consumption patterns for the number of pods, wherein pods in each classification from the number of classifications are pods that exhibit similar or complementary behavior; and
attaching, by the processor set, the subset of pods from the number of pods to each group from the number of groups based on the number of classifications.

17. The computer program product of claim 16, wherein the classification for the number of pods is performed based on the resource consumption patterns for the number of pods and correlations between workloads for the number of pods.

18. The computer program product of claim 15, wherein adjusting, by the processor set, computational resources for each group from the number of groups based on pod behavior and resource consumption pattern for the subset of pods for each group from the number of groups comprises:
reevaluating, by the processor set, pod behavior and resource consumption pattern for the subset of pods for each group from the number of groups; and
adjusting, by the processor set, computational resources for each group from the number of groups based on reevaluations for subsets of pods for each group from the number of groups.

19. The computer program product of claim 15, wherein adjusting, by the processor set, computational resources for each group from the number of groups based on pod behavior and resource consumption pattern for the subset of pods for each group from the number of groups comprises:
performing, by the processor set, time-series analysis for the number of pods to identify usage trends of computational resources for the number of pods;
forecasting, by the processor set using a machine learning model, future computational resources usage for each pod from the number of pods based on the usage trends of computational resources for the number of pods; and
adjusting, by the processor set, computational resources for each group from the number of groups based on the future computational resources usage for each pod from the number of pods.

20. The computer program product of claim 15, wherein adjusting, by the processor set, computational resources for each group from the number of groups based on pod behavior and resource consumption pattern for the subset of pods for each group from the number of groups comprises:
identifying, by the processor set, a number of anomalies based on historical data and real-time data associated with operations for the number of pods, wherein the number of anomalies are irregular patterns associated with operations for the number of pods; and
adjusting, by the processor set, computational resources for each group from the number of groups based on the number of anomalies identified for the number of pods.
